(19) United States
(12) Patent Application Publication
(10) Pub. No.: US 2020/0356932 A1
(43) Pub. Date: Nov. 12, 2020

(54) INFORMATION PROCESSING APPARATUS AND INFORMATION PROCESSING SYSTEM

(71) Applicant: TOSHIBA TEC KABUSHIKI KAISHA, Tokyo (JP)

(72) Inventor: Yoshiyuki HIRAHARA, Mishima Shizuoka (JP)

(21) Appl. No.: 16/803,709

(22) Filed: Feb. 27, 2020

(30) Foreign Application Priority Data
May 8, 2019 (JP) 2019-088247

(51) Int. Cl. G06Q 10/06; G06Q 10/10; G06Q 30/02

(52) U.S. Cl. CPC G06Q 10/06315; G06Q 10/06312; G06Q 30/0202; G06Q 10/1053

(57) ABSTRACT

According to an embodiment, an information processing apparatus includes a storage device and a processor. The storage device stores stay data of shoppers who come in and go out of a store, and shift data of staff for a predetermined operation of the store. The processor outputs, on the basis of the stay data and the shift data, information including information indicating a time slot insufficient in staff members and information indicating the number of insufficient staff members when the number of staff members necessary exceeds the number of staff members registered.

### CROSS-REFERENCE TO RELATED APPLICATIONS

This application is based upon and claims the benefit of priority from the prior Japanese Patent Application No. 2019-088247, filed on May 8, 2019, the entire contents of which are incorporated herein by reference.

### FIELD

An embodiment to be described here generally relates to an information processing apparatus and an information processing system.

### BACKGROUND

There are various techniques of matching a job offer side and a job seeker side with each other. For example, there is a technique of matching a job offer side and a job seeker side with each other by using information input by the job offer side and information input by the job seeker side. For example, there is a technique of providing recruiting information of the job offer side on the Web and receiving applications of the job seeker side on the Web.

Further, for example, the job offer side generally recruits workers for several weeks ahead or several months ahead. Therefore, the job offer side has difficulty of securing workers depending on situations on a day, such as the congestion of the day and the sudden absence of staff members on the day.

### BRIEF DESCRIPTION OF THE DRAWINGS

FIG. 1 is a block diagram illustrating by an example an information processing system according to an embodiment.

FIG. 2 is a diagram illustrating by an example shift data according to the embodiment.

FIG. 3 is a diagram illustrating by an example comparison results according to the embodiment.

FIG. 4 is a diagram illustrating by an example a message addressed to an administrator according to the embodiment.

FIG. 5 is a diagram illustrating by an example a message addressed to a worker candidate according to the embodiment.

FIG. 6 is a diagram illustrating by an example a message for employment according to the embodiment.

FIG. 7 is a diagram illustrating by an example a rejection message according to the embodiment.

FIG. 8 is a flowchart showing an example of an operation of the information processing system according to the embodiment.

FIG. 9 is a flowchart showing another example of an operation of the information processing system according to the embodiment.

### DETAILED DESCRIPTION

According to an embodiment, an information processing apparatus includes a storage device, a network interface, a memory that stores a program, and a processor. The storage device stores data regarding stay of shoppers who come in and go out of a store, and data regarding a shift of staff members for a predetermined operation of the store. The processor executes the program to refer to the data regarding stay of shoppers to predict a situation of the store. Further, the processor predicts the number of staff members necessary on an hourly basis in the predetermined operation of the store on a basis of the situation of the store. Further, the processor acquires the number of staff members registered on an hourly basis in the predetermined operation on a basis of the data regarding a shift of staff members for the predetermined operation. Further, the processor compares the number of staff members necessary and the number of staff members registered with each other on an hourly basis. Further, the processor outputs information of results of the comparison via the network interface, the information including information indicating a time slot insufficient in staff members and information indicating the number of insufficient staff members when the number of staff members necessary exceeds the number of staff members registered.

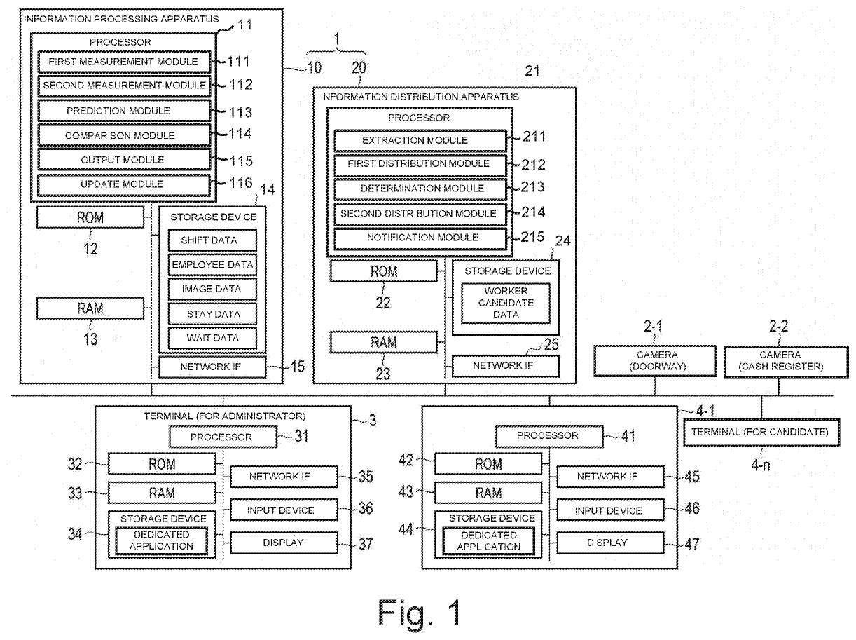

Hereinafter, an embodiment will be described in detail with reference to the drawings. In the drawings, identical reference symbols represent identical or similar parts. FIG. 1 illustrates an example of an information processing system 1. As shown in FIG. 1, the information processing system 1 is a system to support matching of a store with a worker. For example, the store is a working place for staff members, such as a supermarket. The staff members include an employee and a worker. The employee means a person having an employment relationship with the store. The worker means a person who works at the store for a short time of a day, such as a part-time worker.

For a typical example, the information processing system 1 is a system to support matching of a store with a worker in a time slot in which a plurality of cash registers within the store are crowded with shoppers and which needs more staff members for a checkout operation. For example, the information processing system 1 supports matching a supermarket in a high-rise condominium with a person who lives in the high-rise condominium. This allows the supermarket to easily gather workers for sudden recruiting for a part-time job on a day. Meanwhile, a person who lives near the supermarket can work for a short time using his/her spare time, because the travelling time to the supermarket is short. Hereinafter, description will be given assuming that the supermarket is an example of the store. A part or all of the information processing system 1 may be installed within the store, but it may be installed outside the store.

The information processing system 1 includes an information processing apparatus 10 and an information distribution apparatus 20. The configuration examples of the information processing apparatus 10 and the information distribution apparatus 20 will be described later. For example, the information processing system 1 connects to a camera 2-1, a camera 2-2, a terminal 3, and n (n is integer of 1 or more) terminals 4-1 to 4-n via a network within the store or a network such as the Internet.

The camera 2-1 will be described. The camera 2-1 is installed in the vicinity of the doorway of the store. The camera 2-1 captures images of shoppers who come in and go out of the store. The camera 2-1 transmits time-series image data to the information processing apparatus 10. The camera 2-1 may continuously transmit the image data to the information processing apparatus 10 or may transmit the image data, which is gathered in a predetermined period, to the information processing apparatus 10 for each predetermined period. It should be noted that the number of cameras that capture images of shoppers who come in and go out of the store is not limited to one and may be more than one.

The camera 2-2 will be described. The camera 2-2 is installed in the vicinity of a plurality of cash registers of the store. The camera 2-2 captures images of shoppers who are waiting for checkout at a plurality of cash registers. The camera 2-2 transmits time-series image data to the information processing apparatus 10. The camera 2-2 may continuously transmit the image data to the information processing apparatus 10 or may transmit the image data, which is gathered in a predetermined period, to the information processing apparatus 10 for each predetermined period. It should be noted that the number of cameras that capture images of shoppers who are waiting for checkout at a plurality of cash registers is not limited to one and may be the number corresponding to the number of cash registers.

The terminal 3 will be described. The terminal 3 is a terminal used by a particular person of the store. Here, the particular person is assumed as an administrator such as a store manager. For example, the terminal 3 is a personal computer (PC), a smartphone, a tablet, or the like, but it is not limited thereto.

As shown in FIG. 1, the terminal 3 includes a processor 31, a ROM (Read Only Memory) 32, a RAM (Random Access Memory) 33, a storage device 34, a network interface 35, an input device 36, and a display 37. Those units 31 to 37 constituting the terminal 3 are connected to one another via a data bus. In FIG. 1, the network interface is described as “network IF”.

The processor 31 controls the whole operation of the terminal 3. For example, the processor 31 is a central processing unit (CPU). The processor 31 executes programs stored in advance in the ROM 32, the storage device 34, or the like to achieve various functions.

The ROM 32 is a nonvolatile memory that stores a control program, control data, and the like in advance. The ROM 32 may store a dedicated application program that processes information transmitted from the information processing system 1.

The RAM 33 is a volatile memory. The RAM 33 temporarily stores data being processed by the processor 31 and the like. The RAM 33 stores various application programs on the basis of a command from the processor 31. Further, the RAM 33 may store data used for execution of the application programs, execution results of the application programs, and the like.

The storage device 34 is a data readable and rewritable nonvolatile memory. For example, the storage device 34 includes an HDD (Hard Disk Drive), an SSD (Solid State Drive), an EEPROM (registered trademark) (Electrically Erasable Programmable Read-Only Memory), a flash memory, or the like. The storage device 34 may store a dedicated application program that processes information transmitted from the information processing system 1.

The network interface 35 is a communication interface for transmitting and receiving data in a wired or wireless manner. For example, the network interface 35 includes various interfaces that support connection according to various standards.

The input device 36 is a device that receives an instruction on the basis of the operation of the administrator. For example, the input device 36 is a keyboard, a touch pad, or the like, but it is not limited thereto.

The display 37 is a device that displays various screens. For example, the display 37 is a liquid crystal display, but it is not limited thereto.

The terminals 4-1 to 4-n will be described. The terminals 4-1 to 4-n are terminals used by worker candidates. The worker candidate is a person registered in advance as a candidate of a worker. The worker candidates are managed using worker candidate data, which is stored in the information distribution apparatus 20, as will be described later. The terminals 4-1 to 4-n are PCs, smartphones, tablets, or the like, but the terminals 4-1 to 4-n are not limited thereto. It should be noted that, in the following description, at least one of the terminals 4-1 to 4-n is referred to as the terminal(s) 4.

The terminal 4-1 includes a processor 41, a ROM 42, a RAM 43, a storage device 44, a network interface 45, an input device 46, and a display 47. Those units 41 to 47 constituting the terminal 4-1 are connected to one another via a data bus. The processor 41, the ROM 42, the RAM 43, the storage device 44, the network interface 45, the input device 46, and the display 47 are respectively configured in a manner similar to the processor 31, the ROM 32, the RAM 33, the storage device 34, the network interface 35, the input device 36, and the display 37 described above. The ROM 42 or the storage device 44 may store a dedicated application program that processes information transmitted from the information processing system 1. It should be noted that the terminals 4-2 to 4-n have the configuration similar to the configuration of the terminal 4-1, and thus the description thereof will be omitted.

The information processing apparatus 10 will be described. The information processing apparatus 10 is an apparatus that acquires in real time a situation in which staff members are insufficient in a predetermined operation of the store. Here, the checkout operation will be described as an example of the predetermined operation. The information processing apparatus 10 includes a processor 11, a ROM 12, a RAM 13, a storage device 14, and a network interface 15. The processor 11, the ROM 12, the RAM 13, the storage device 14, and the network interface 15 respectively have the configurations similar to the configurations of the processor 31, the ROM 32, the RAM 33, the storage device 34, and the network interface 35.

The storage device 14 stores shift data, employee data, image data, stay data, and wait data.

The shift data is data regarding a shift indicating an assignment of staff members to various operations of the store, such as a checkout operation and a goods-supplementing operation. The shift data is data registered on a daily basis with a time slot and identification information of staff members (for example, name or identification data ID) being associated with each other. For example, the shift data is created by the administrator at the terminal 3 and stored in the storage device 14. The shift data is appropriately updated by the addition or deletion made by the administrator. For example, the administrator can also remove, on the basis of a previous announcement of absence from a certain staff member, this staff member from the shift of a relevant day. For example, the shift data may be updated by an update module 116 of the processor 11, which will be described later. Therefore, the shift data means not only the data indicating a temporarily determined assignment of staff members but also the data updated according to a change after the determination in some cases.

The employee data is data of a list of identification information of employees of the store. For example, the employee data is created by the administrator at the terminal 3 and stored in the storage device 14. The employee data is appropriately updated by the addition or deletion made by the administrator.

The image data includes time-series image data of shoppers who come in and go out of the store and time-series image data of shoppers who are waiting for checkout at a plurality of cash registers. The image data of the shoppers who come in and go out of the store is captured by the camera 2-1 and stored in the storage device 14. The image data of the shoppers who are waiting for checkout at the plurality of cash registers are captured by the camera 2-2 and stored in the storage device 14. Each time the information processing apparatus 10 acquires the image data from the camera 2-1 and the camera 2-2 to be added to the image data stored in the storage device 14, the image data stored in the storage device 14 is appropriately updated.

The stay data is data including a mean dwell time, during which the shoppers who come in and go out of the store stay in the store, and a mean number of staying shoppers in the store. The data of the mean dwell time and the data of the mean number of staying shoppers are each data of a mean value per time slot. The width of a time slot can be optionally set. The data of the mean dwell time and the data of the mean number of staying shoppers are each associated with conditions in which a day of the week, weather, and whether it is a holiday or not, and the like are combined. The mean dwell time is measured by a first measurement module 111 of the processor 11, which will be descried later, on the basis of the image data of the shoppers who come in and go out of the store. The mean number of staying shoppers is measured by a second measurement module 112 of the processor 11, which will be descried later, on the basis of the mage data of the shoppers who come in and go out of the store. Each time the first measurement module 111 daily measures the mean dwell time to be added to the stay data, the stay data is appropriately updated. Each time the second measurement module 112 daily measures the mean number of staying shoppers to be added to the stay data, the stay data is appropriately updated.

The wait data is data including a mean waiting time of shoppers who are waiting for checkout at cash registers, and a mean number of waiting shoppers. The data of the mean waiting time and the data of the mean number of waiting shoppers are each data of a mean value per time slot. The width of a time slot can be optionally set. The data of the mean waiting time and the data of the mean number of waiting shoppers are each associated with the conditions described above. The mean waiting time is measured by the first measurement module 111 of the processor 11, which will be descried later, on the basis of the image data of the shoppers who are waiting for checkout at cash registers. The mean number of waiting shoppers is measured by the second measurement module 112 of the processor 11, which will be descried later, on the basis of the image data of the shoppers who are waiting for checkout at cash registers. The mean number of waiting shoppers may be a mean value per time slot of the number of shoppers waiting at each cash register of the store or may be a mean value per time slot of the number of shoppers waiting in each store. Each time the first measurement module 111 daily measures the mean waiting time to be added to the wait data, the wait data is appropriately updated. Each time the second measurement module 112 daily measures the mean number of waiting shoppers to be added to the wait data, the wait data is appropriately updated.

The functions achieved by the processor 11 will be described. The processor 11 executes application programs stored in the ROM 12, the storage device 14, and the like, to achieve the functions of the first measurement module 111, the second measurement module 112, a prediction module 113, a comparison module 114, an output module 115, and an update module 116.

The first measurement module 111 measures an entrance time and a leaving time of each shopper in real time by the analysis of the image data of the shoppers who come in and go out of the store. The first measurement module 111 measures a dwell time of each shopper in real time on the basis of the difference between the entrance time and the leaving time. The first measurement module 111 classifies, at a predetermined timing, the dwell time of each shopper per time slot and measures a mean dwell time per time slot. The first measurement module 111 associates the data per time slot of the mean dwell time of the shoppers who come in and go out of the store, with the conditions of the day, and stores them in the storage device 14.

The first measurement module 111 measures a start time of waiting for the turn for cash registers and an end time of waiting for the turn for cash registers of each shopper in real time by the analysis of the image data of the shoppers who are waiting for checkout at cash registers. The first measurement module 111 measures a waiting time of each shopper in real time on the basis of the difference between the start time and the end time of waiting for the turn for cash registers. The first measurement module 111 classifies, at a predetermined timing, the waiting time of each shopper per time slot and measures a mean waiting time per time slot. The first measurement module 111 associates the data per time slot of the mean waiting time of the shoppers waiting at the cash registers, with the conditions of the day, and stores them in the storage device 14.

The second measurement module 112 measures the entrance time and the leaving time of each shopper in real time by the analysis of the image data of the shoppers who come in and go out of the store. The second measurement module 112 measures in real time the number of staying shoppers on an hourly basis on the basis of the difference between the entrance time and the leaving time of each shopper. The second measurement module 112 classifies, at a predetermined timing, the number of staying shoppers per time slot and measures a mean number of staying shoppers per time slot. The second measurement module 112 associates the data per time slot of the mean number of staying shoppers who come in and go out of the store, with the conditions of the day, and stores them in the storage device 14.

The second measurement module 112 measures in real time the number of waiting shoppers on an hourly basis by the analysis of the image data of the shoppers who are waiting for checkout at cash registers. The second measurement module 112 classifies, at a predetermined timing, the number of waiting shoppers per time slot and measures a mean number of waiting shoppers per time slot. The second measurement module 112 associates the data per time slot of the mean number of waiting shoppers who are waiting at the cash registers, with the conditions of the day, and stores them in the storage device 14.

The prediction module 113 predicts the number of necessary staff members on an hourly basis in the checkout operation of the store on the basis of a situation of the store as will be described below as an example. In a typical example, the prediction module 113 predicts the number of necessary staff members at a plurality of prediction timings of a day. In this example, the prediction module 113 predicts, at a plurality of prediction timings of a day, the number of necessary staff members on an hourly basis in a first predetermined period later than each of the prediction timings. The first predetermined period is a time period that starts at a time after the elapse of the second predetermined period starting from a time of a prediction timing. The second predetermined period is set so as to secure a time for recruiting staff members in a case where the staff members are insufficient in the first predetermined period. For example, the width of the first predetermined period is two hours or the like, but it can be optionally set. For example, the width of the second predetermined period is 45 minutes or the like, but it can be optionally set. The plurality of prediction timings of a day is set so as to prevent a reduction in prediction accuracy for the number of necessary staff members, because a situation of a day changes with time. Hereinafter, an example in which the plurality of prediction timings of a day are set will be described. The prediction module 113 repeats a prediction at each prediction timing in the first predetermined period and thus continuously predicts the number of necessary staff members on an hourly basis from the opening time to the closing time of the store.

First, a situation of the store will be described. For example, a situation of the store is an hourly congestion situation of the store. The congestion situation includes at least one of a feature dwell time, waiting time, number of staying shoppers, or number of waiting shoppers, which are predicted by the prediction module 113. In the following, a feature dwell time predicted by the prediction module 113 is also referred to as a predicted dwell time in some cases. Further, a feature waiting time predicted by the prediction module 113 is also referred to as a predicted waiting time in some cases. Further, a feature number of staying shoppers predicted by the prediction module 113 is also referred to as a predicted number of staying shoppers in some cases. Further, a feature number of waiting shoppers predicted by the prediction module 113 is also referred to as a predicted number of waiting shoppers in some cases. As the predicted dwell time or the predicted waiting time becomes longer, the degree of congestion tends to increase. As the predicted number of staying shoppers or the predicted number of waiting shoppers becomes larger, the degree of congestion tends to increase.

Next, a prediction example of the predicted dwell time will be described. For example, the prediction module 113 refers to the stay data stored in the storage device 14. The prediction module 113 identifies a past day, which has the conditions matched with or similar to those of the current day and which has the passage of the mean dwell time per time slot from the opening of the store to a prediction timing, matched with or similar to that of the current day. The prediction module 113 refers to the data of a mean dwell time per time slot of the identified past day and predicts a predicted dwell time on an hourly basis after the prediction timing. It should be noted that the prediction module 113 predicts a predicted dwell time on an hourly basis after the prediction timing by matching of the data of the current day and the past stay data, but it is not limited thereto. For example, the prediction module 113 may generate a prediction model of the predicted dwell time on an hourly basis from the past stay data to predict a predicted dwell time on an hourly basis by using the prediction model. For example, the prediction model may use, as parameters, the mean dwell times or the like per day of the week, weather, and whether it is a holiday or not and per time slot from the opening of the store to a prediction timing, to calculate a predicted dwell time on an hourly basis after the prediction timing. The prediction module 113 can predict a predicted waiting time, a predicted number of staying shoppers, and a predicted number of waiting shoppers, in a manner similar to the predicted dwell time.

Next, a prediction example of the number of staff members necessary on an hourly basis will be described. For example, the prediction module 113 predicts the number of staff members necessary on an hourly basis, on the basis of at least one of a predicted dwell time, a predicted waiting time, a predicted number of staying shoppers, or a predicted number of waiting shoppers on an hourly basis. The prediction module 113 may refer to the data, by which at least one or more combinations of the predicted dwell time, the predicted waiting time, the predicted number of staying shoppers, and the predicted number of waiting shoppers is associated with the number of necessary staff members, to predict the number of staff members necessary on an hourly basis. As the predicted dwell time or the predicted waiting time becomes longer, the number of necessary staff members tends to increase. As the predicted number of staying shoppers or the predicted number of waiting shoppers becomes larger, the number of necessary staff members tends to increase.

The comparison module 114 acquires the number of staff members registered on an hourly basis regarding the checkout operation, on the basis of the shift data of the checkout operation, as will be described as an example as follows. The comparison module 114 compares the number of necessary staff members and the number of registered staff members with each other on an hourly basis. In a typical example, the comparison module 114 compares the number of necessary staff members and the number of registered staff members with each other on an hourly basis for the first predetermined period.

First, the comparison module 114 refers to the shift data of the checkout operation in the shift data stored in the storage device 14. The comparison module 114 acquires the number of staff members registered on an hourly basis regarding the checkout operation for the first predetermined period. The number of registered staff members is the number of staff members assigned on an hourly basis in the first predetermined period. Next, the comparison module 114 compares the number of necessary staff members, which is predicted by the prediction module 113, and the number of registered staff members with each other on an hourly basis. The comparison module 114 calculates the number of staff members, which is obtained by subtracting the number of registered staff members from the number of necessary staff members on an hourly basis. A time slot in which the number of necessary staff members exceeds the number of registered staff members is a time slot insufficient in staff members. For example, a plurality of time slots insufficient in staff members may be present discontinuously in the first predetermined period. For example, in a case where the number of staff members, which is obtained by subtracting the number of registered staff members from the number of necessary staff members, is two or more, a plurality of time slots insufficient in staff members may be present while partially overlapping each other in the first predetermined period. The comparison module 114 calculates the presence/absence of the time slot insufficient in staff members in the first predetermined period, the time slot insufficient in staff, and the number of insufficient staff members, on the basis of the number of staff members, which is obtained by subtracting the number of registered staff members from the number of necessary staff members on an hourly basis. The number of insufficient staff members may be the number of insufficient staff members per time slot insufficient in staff members or may be the total number of insufficient staff members in the first the predetermined period. The comparison results by the comparison module 114 include information indicating the presence/absence of the time slot insufficient in staff members in the first predetermined period. In a case where there is a time slot insufficient in staff members, the comparison results include information indicating the time slot insufficient in staff members in the first predetermined period and information indicating the number of insufficient staff members.

The output module 115 outputs the information based on the comparison results by the comparison module 114 via the network interface 15. For example, the output module 115 outputs a message addressed to an administrator to the terminal 3 as will be illustrated by an example. The message addressed to an administrator is an example of the information based on the comparison results. The case where the comparison results include the information indicating the absence of the time slot insufficient in staff members in the first predetermined period will be described. The output module 115 outputs the message addressed to an administrator to the terminal 3. The message addressed to an administrator includes information indicating the checkout operation and the information indicating the absence of the time slot insufficient in staff members in the first predetermined period. Thus, the display 37 of the terminal 3 displays the message addressed to an administrator. The administrator can grasp that there is no time slot insufficient in staff members in the first predetermined period.

The case where the comparison results include the information indicating the presence of the time slot insufficient in staff members in the first predetermined period will be described. The output module 115 outputs the message addressed to an administrator to the terminal 3. The message addressed to an administrator is a message for presenting a situation, in which the staff members are insufficient in the first predetermined period, to the administrator. The message addressed to an administrator includes the information indicating the checkout operation, the information indicating a time slot insufficient in staff members in the first predetermined period, information indicating the number of insufficient staff members, information indicating possible employees, and information indicating the number of worker candidates. The possible employees mean the employees who do not work on the current day among the employees. The output module 115 refers to the shift data and the employee data stored in the storage device 14 and identifies the possible employees. The number of worker candidates is the number of worker candidates who satisfy a predetermined criterion among the worker candidates managed by the worker candidate data, which is stored in the information distribution apparatus 20. The predetermined criterion will be described later. It should be noted that the number of worker candidates may be the number of all worker candidates managed by the worker candidate data, which is stored in the information distribution apparatus 20. The output module 115 outputs a request for the number of worker candidates to the information distribution apparatus 20, and acquires information indicating the number of worker candidates, as a response with respect to the request for the number of worker candidates, from the information distribution apparatus 20. Thus, the display 37 of the terminal 3 displays the message addressed to an administrator.

The administrator can confirm the message addressed to an administrator and eventually determine whether to recruit workers or not. The administrator may confirm the possible employees to directly contact an employee who has day off on that day so as to come, to determine that recruiting of workers is unnecessary. The administrator may allocate the staff members for operations other than the checkout operation to the checkout operation, to determine that recruiting of workers is unnecessary, by. The administrator may confirm the number of worker candidates and determine whether to recruit workers on the basis of the possibility that workers are gathered. The administrator can input an instruction to recruit workers by using the input device 36 of the terminal 3. In a case where there is a plurality of time slots insufficient in staff members, the administrator may input the instruction to recruit workers per time slot insufficient in staff members.

The output module 115 outputs a request to recruit workers to the information distribution apparatus 20 on the basis of the instruction to recruit workers from the terminal 3. The request to recruit workers includes information based on the comparison results. For example, the information based on the comparison results includes the information indicating the checkout operation, the information indicating the time slot insufficient in staff members in the first predetermined period, and the information indicating the number of insufficient staff members.

It should be noted that the output module 115 may omit the output of the message addressed to an administrator to the terminal 3 and may output the request to recruit workers to the information distribution apparatus 20.

The update module 116 updates the shift data on the basis of the worker information from the information distribution apparatus 20. The worker information is information obtained by associating the time slot insufficient in staff members with the identification information of a worker selected from the worker candidates.

The information distribution apparatus 20 will be described. The information distribution apparatus 20 is an apparatus that gives support to secure a worker for the checkout operation in real time. The information distribution apparatus 20 includes a processor 21, a ROM 22, a RAM 23, a storage device 24, and a network interface 25. The processor 21, the ROM 22, the RAM 23, the storage device 24, and the network interface 25 respectively have configurations similar to the configurations of the processor 31, the ROM 32, the RAM 33, the storage device 34, and the network interface 35 described above.

The storage device 24 stores the worker candidate data. The worker candidate data is data regarding a plurality of registered worker candidates. For example, the worker candidate data includes, for each of the worker candidates, information such as identification information, an address, and the performance in employment as a worker. For example, the performance in employment is the number of times employed or the number of times applying for jobs up to this point or the number of times employed or the number of times applying for jobs for a certain period of time, e.g., within the past one month, but it is not limited thereto. The worker candidate data is appropriately updated by the addition, deletion, or the like of the worker candidates.

The functions achieved by the processor 21 will be described. The processor 21 executes application programs stored in the ROM 22 or the storage device 24, to achieve the functions of an extraction module 211, a first distribution module 212, a determination module 213, a second distribution module 214, and a notification module 215.

The extraction module 211 acquires a request for the number of worker candidates from the information processing apparatus 10 via the network interface 25. The extraction module 211 refers to the worker candidate data, which is stored in the storage device 24, on the basis of the request for the number of worker candidates. The extraction module 211 extracts a worker candidate who satisfies a predetermined criterion from the worker candidates managed by the worker candidate data. The predetermined criterion is a criterion for extracting suitable worker candidates. The predetermined criterion may be a distance from the store or the performance in employment, but it is not limited thereto. The extraction module 211 stores, in the storage device 24, information indicating the worker candidates who satisfy the predetermined criterion. The extraction module 211 counts the number of worker candidates who satisfy the predetermined criterion and outputs information indicating the number of worker candidates to the information processing apparatus 10. It should be noted that the extraction module 211 counts the number of all worker candidates managed by the worker candidate data, which is stored in the information distribution apparatus 20, to calculate the number of worker candidates.

The first distribution module 212 acquires a request to recruit workers, which includes the information based on the comparison results, from the information processing apparatus 10 via the network interface 25. The first distribution module 212 distributes a message addressed to a worker candidate to the terminal 4 of a worker candidate extracted by the extraction module 211, on the basis of the acquisition of the request to recruit workers. The message addressed to a worker candidate is an example of information to recruit workers in a time slot insufficient in staff members. The message addressed to a worker candidate includes various types of information for the worker candidates to determine whether to apply for the job or not. For example, the message addressed to a worker candidate includes information such as a recruiting operation, a recruiting time slot, the number of people to be recruited. Examples of the message addressed to a worker candidate will be described later. Thus, the display 47 of the terminal 4 displays the message addressed to a worker candidate. A worker candidate who has received the message addressed to a worker candidate can apply for the job for his/her own convenience.

The determination module 213 acquires information indicating the application for the job from the terminal 4 via the network interface 25. The determination module 213 determines a worker from the worker candidates who had applied for job with respect to the message addressed to a worker candidate. Hereinafter, the worker candidate who had applied for the job with respect to the message addressed to a worker candidate is called an applicant in some cases. In an example, the determination module 213 determines a worker on a first-come and first-served basis within a third predetermined period. In this example, in a case where the number of applicants reaches the number of people to be recruited, the determination module 213 determines the termination of worker recruiting even before the elapse of the third predetermined period. The third predetermined period is a time period from a distribution time of the message addressed to a worker candidate to a time before a time at which the first predetermined period starts. The third predetermined period is set so as to secure a time period, during which the worker arrives at the store. For example, the width of the third predetermined period is five minutes or the like, but it can be changed optionally.

In another example, the determination module 213 determines a worker in an order of a shorter distance from the address of the store to the address of each applicant, from the applicants who had applied for the job within the third predetermined period among the worker candidates to which the message addressed to a worker candidate has been distributed. In this example, the determination module 213 receives applications till the elapse of the third predetermined period. The determination module 213 determines a worker from the applicants after the elapse of the third predetermined period. The determination module 213 calculates a distance from the address of the store to the address of each applicant on the basis of the latitude and longitude of the addresses. According to this example, the worker is determined in an order of a distance closer to the store among the applicants. Thus, the worker can be expected to come to the store without being late for the time slot insufficient in staff members.

In still another example, the determination module 213 determines a worker in an order of higher performance in employment from the applicants who had applied for the job within the third predetermined period among the worker candidates to which the message addressed to a worker candidate has been distributed. In this example, the determination module 213 receives applications till the elapse of the third predetermined period. The determination module 213 determines a worker from the applicants after the elapse of the third predetermined period. The determination module 213 refers to the performance in employment managed by the worker candidate data, which is stored in the storage device 24. According to this example, the worker is determined in an order of higher performance in employment among the applicants. Thus, the worker can be expected to perform the checkout operation effectually.

The second distribution module 214 distributes various messages to the terminals 4 of the worker candidates, to which the message addressed to a worker candidate has been distributed, via the network interface 25. For example, the second distribution module 214 distributes a message for closing of application to the terminals 4 of the worker candidates, to which the message addressed to a worker candidate has been distributed, on the basis of the determination to terminate recruiting by the determination module 213. The message for closing of application includes information indicating that the reception of applications has been closed. Similarly, the second distribution module 214 distributes a message for closing of application to the terminals 4 of the worker candidates, to which the message addressed to a worker candidate has been distributed, on the basis of the elapse of the third predetermined period. It should be noted that the second distribution module 214 may omit the distribution of the message for closing of application to the terminals 4 of the applicants. For example, the second distribution module 214 distributes a message for employment to the terminal 4 of a worker determined from the applicants by the determination module 213. The message for employment includes information indicating that the applicant is employed as a worker. The message for employment will be described later. For example, the second distribution module 214 distributes a rejection message to the terminals 4 of the applicants excluding the worker determined by the determination module 213. The rejection message includes information indicating that the applicant is not employed as a worker. The rejection message will be described later.

The notification module 215 notifies the information processing apparatus 10 of worker information regarding the worker determined by the determination module 213 via the network interface 25.

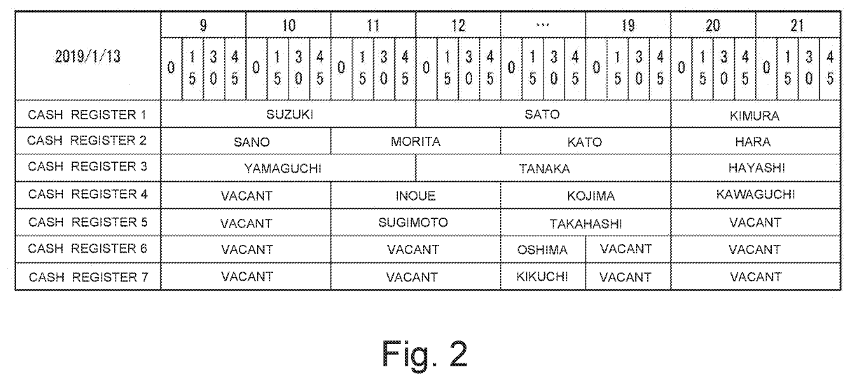

The shift data described above will be described. FIG. 2 is a diagram illustrating by an example the shift data. FIG. 2 shows the shift data of a checkout operation on a certain day. For example, it is assumed that the opening time is at 9 o'clock and the closing time is 22 o'clock. The time period during which the staff members work is assigned on a 15-minute basis. A maximum number of staff members for the checkout operation is seven.

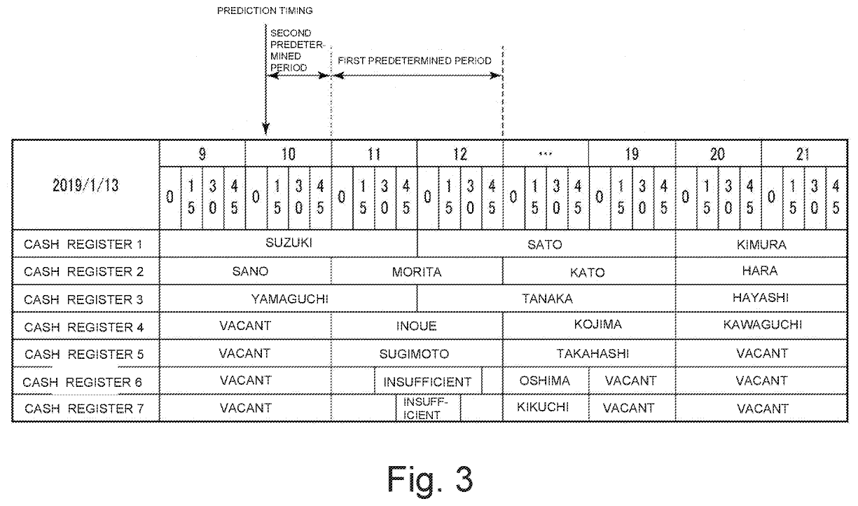

The comparison results by the comparison module 114 described above will be described. FIG. 3 is a diagram illustrating by an example the comparison results. It is assumed that the prediction timing is at 10:15, and the first predetermined period is two hours. It is assumed that the second predetermined period is 45 minutes, and the number of staff members registered in a time period from 11:00 to 13:00 is five. The prediction module 113 predicts the number of staff members necessary on an hourly basis in the time period from 11:00 to 13:00. It is assumed that the prediction module 113 predicts five for the number of necessary staff members from 11:00 to 11:30. It is assumed that the prediction module 113 predicts six for the number of necessary staff members from 11:30 to 11:45. It is assumed that the prediction module 113 predicts seven for the number of necessary staff members from 11:45 to 12:30. It is assumed that the prediction module 113 predicts six for the number of necessary staff members from 12:30 to 12:45. It is assumed that the prediction module 113 predicts five for the number of necessary staff members from 12:45 to 13:00.

The comparison module 114 compares the number of necessary staff members and the number of registered staff members with each other on an hourly basis in the time period from 11:00 to 13:00. The number of staff members obtained by subtracting the number of registered staff members from the number of necessary staff members is one from 11:30 to 11:45, two from 11:45 to 12:15, and one from 12:15 to 12:45. The comparison results by the comparison module 114 include information indicating the presence of the time slot insufficient in staff members. The comparison results include information indicating that the time slot insufficient in staff members is between 11:30 and 12:45 and between 11:45 to 12:15. The comparison results include information indicating that the number of insufficient staff members is one from 11:30 to 12:45 and one from 11:45 to 12:15. The comparison results include information indicating that the number of insufficient staff members from 11:00 to 13:00 is two in total.

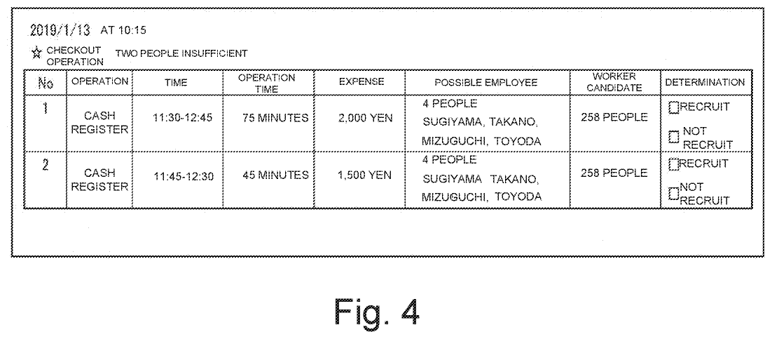

The message addressed to an administrator described above will be described. FIG. 4 is a diagram illustrating by an example the message addressed to an administrator. The output module 115 of the information processing apparatus 10 generates a message addressed to an administrator and outputs it to the terminal 3. The display 37 of the terminal 3 displays the message addressed to an administrator.

The message addressed to an administrator includes an “operation” column, a “time” column, an “operation time” column, an “expense” column, a “possible employee” column, a “worker candidate” column, and a “determination” column. The “operation” column is a column for information indicating an operation in which staff members are insufficient. The “time” column is a column for information indicating a time slot insufficient in staff members. The “operation time” column is a column for information indicating a time period in a time slot insufficient in staff members. The “expense” column is a column for information indicating the expense necessary for recruiting in a time slot insufficient in staff members. The expense is determined according to an hourly rate and the length of an operation time. In a case where the hourly rate has a range, the “expense” column may indicate the lower limit cost and the upper limit cost. The “possible employee” column is a column for information indicating possible employees. The “worker candidate” column is a column for information indicating the number of worker candidates. The “determination” column includes a button for the administrator to determine whether recruiting is necessary or not. The message addressed to an administrator includes information indicating the number of insufficient staff members (in FIG. 4, two in total for the number of insufficient staff members per time slot insufficient in staff members) on the outside of the columns. The administrator can select the button of the “determination” column by using the input device 36 of the terminal 3, to input an instruction to recruit workers.

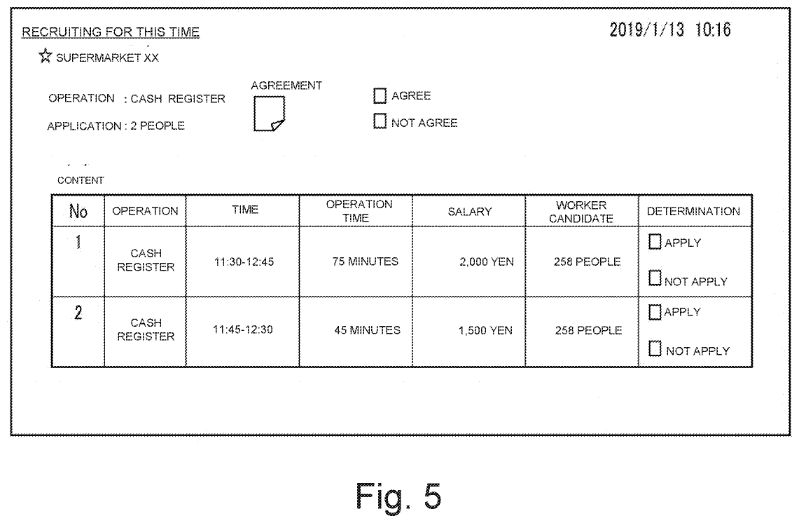

The message addressed to a worker candidate described above will be described. FIG. 5 is a diagram illustrating by an example the message addressed to a worker candidate. The first distribution module 212 of the information distribution apparatus 20 generates a message addressed to a worker candidate and distributes the generated message addressed to a worker candidate to the terminal 4. The display 47 of the terminal 4 displays the message addressed to a worker candidate. The display 47 of the terminal 4 updates the message addressed to a worker candidate in real time for display, each time the terminal 4 receives the message addressed to a worker candidate from the information distribution apparatus 20.

The message addressed to a worker candidate includes an “operation” column, a “time” column, an “operation time” column, a “salary” column, a “worker candidate” column, and a “determination” column. The “operation” column is a column for information indicating an operation for recruiting. The operation for recruiting corresponds to an operation insufficient in staff members. The “time” column is a column for information indicating a time slot for recruiting. The time slot for recruiting corresponds to the time slot insufficient in staff members. The “operation time” column is a column for information indicating a time period in the time slot for recruiting. The “salary” column is a column for information indicating the salary in the time slot for recruiting. The salary in the time slot for recruiting corresponds to the cost necessary for recruiting in the time slot insufficient in staff members. The “worker candidate” column is a column for information indicating the number of worker candidates. The “determination” column includes a button for the worker candidate to determine whether to apply for it or not. The message addressed to a worker candidate includes information indicating the number of people to be recruited (in FIG. 5, two in total for the number of insufficient staff members per time slot for recruiting) on the outside of the columns. The worker candidate can select the button of the “determination” column by using the input device 46 of the terminal 4, to input an instruction to apply. The terminal 4 transmits the information indicating the application, on the basis of the input of the instruction to apply, to the information distribution apparatus 20.

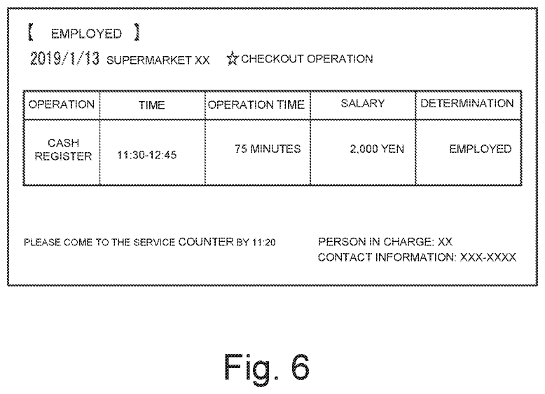

The message for employment described above will be described. FIG. 6 is a diagram illustrating by an example the message for employment. The second distribution module 214 of the information distribution apparatus 20 generates a message for employment and distributes the generated message for employment to the terminal 4 of a person who has been employed as a worker, via the network interface 25. The display 47 of the terminal 4 displays the message for employment.

The message for employment includes an “operation” column, a “time” column, an “operation time” column, a “salary” column, and a “determination” column. The “operation” column is a column for information indicating an operation for recruiting. The “time” column is a column for information indicating a time slot for recruiting. The “salary” column is a column for information indicating the salary in the time slot for recruiting. The salary may be fixed or may be an amount calculated on the basis of a time period during which the employed person has ever worked for the checkout operation, an operation speed per unit time, reputations from shoppers, and the like. The “determination” column is a column for information indicating the employment.

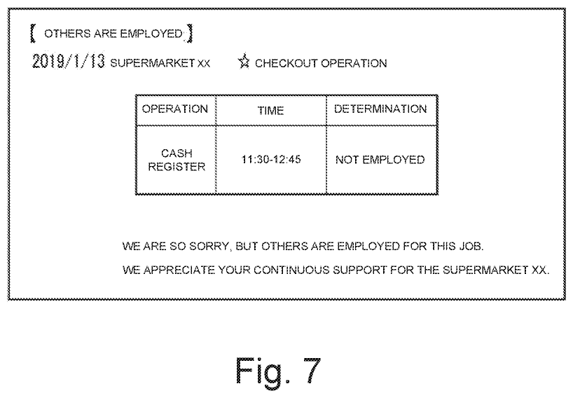

The rejection message described above will be described. FIG. 7 is a diagram illustrating by an example the rejection message. The second distribution module 214 of the information distribution apparatus 20 generates the rejection message and distributes the generated rejection message to the terminals 4 of the rest of the applicants excluding the person employed as a worker. The display 47 of the terminal 4 displays the rejection message.

The rejection message includes an “operation” column, a “time” column, and a “determination” column. The “operation” column is a column for information indicating the operation for recruiting. The “time” column is a column for information indicating the time slot for recruiting. The “determination” column is a column for information indicating that the applicant is rejected.

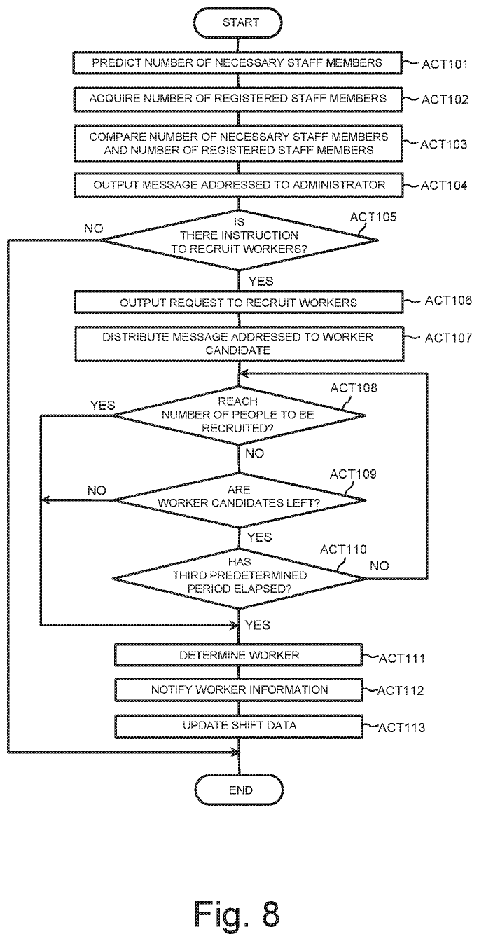

The operation of the information processing system 1 will be described. FIG. 8 is a flowchart showing an example of the operations of the processor 11 of the information processing apparatus 10 and the processor 21 of the information distribution apparatus 20 in the information processing system 1. In other words, here, an example in which the output module 115 of the processor 11 outputs the message addressed to an administrator to the terminal 3, and the determination module 213 of the processor 21 determines a worker on a first-come and first-served basis within the third predetermined period.

First, as shown in FIG. 7, the information processing apparatus 10 starts the processing. In ACT101, the prediction module 113 of the processor 11 predicts, at a prediction timing, the number of staff members necessary on an hourly basis in the checkout operation for the first predetermined period. In ACT102, the comparison module 114 of the processor 11 acquires the number of staff members registered on an hourly basis regarding the checkout operation on the basis of the shift data of the checkout operation. In ACT103, the comparison module 114 compares the number of necessary staff members and the number of registered staff members with each other on an hourly basis. In ACT104, the output module 115 of the processor 11 outputs the message addressed to an administrator to the terminal 3.

In ACT105, the output module 115 of the processor 11 determines whether an instruction to recruit workers has been received from the terminal 3 or not. If the output module 115 has not received the instruction to recruit workers from the terminal 3 (NO in ACT105), the operation of the processor 11 of the information processing system 1 is terminated. If the output module 115 has received the instruction to recruit workers from the terminal 3 (YES in ACT105), the processing of the processor 11 proceeds to ACT106. In ACT106, the output module 115 of the processor 11 outputs a request to recruit workers to the information distribution apparatus 20.

Next, the processing moves to the processing of the processor 21 of the information distribution apparatus 20. In other words, in ACT107, the first distribution module 212 of the processor 21 distributes a message addressed to a worker candidate to the terminals 4 of the worker candidates on the basis of the acquisition of the request to recruit workers. In ACT108, the determination module 213 of the processor 21 determines whether the number of applicants reaches the number of people to be recruited. If the determination module 213 determines that the number of applicants does not reach the number of people to be recruited (NO in ACT108), the processing of the processor 21 proceeds to ACT109. In ACT109, the determination module 213 of the processor 21 determines whether the worker candidates to which the message addressed to a worker candidate is distributed are left or not. For example, if the number of applicants reaches the number of worker candidates to which the message addressed to a worker candidate has been distributed, the determination module 213 determines that the worker candidates are not left. If the determination module 213 determines that the worker candidates to which the message addressed to a worker candidate is distributed are left (YES in ACT109), the processing of the processor 21 proceeds to ACT110. In ACT110, the determination module 213 of the processor 21 determines whether the third predetermined period has elapsed or not.

If the determination module 213 of the processor 21 determines that the third predetermined period has elapsed (YES in ACT110), the processing of the processor 21 proceeds to ACT111. In ACT111, the determination module 213 of the processor 21 determines a worker on a first-come and first-served basis. Further, if the determination module 213 determines that the third predetermined period has not elapsed (NO in ACT110), the processing of the processor 21 returns to ACT108. The processor 21 then repeats the above-mentioned processing from ACT108 to ACT110. Meanwhile, if the determination module 213 determines that the number of applicants reaches the number of people to be recruited (YES in ACT108), the processing of the processor 21 proceeds to ACT111. Then, the determination module 213 of the processor 21 determines a worker on a first-come and first-served basis in the above-mentioned ACT111. Further, if the determination module 213 determines that the worker candidates to which the message addressed to a worker candidate is distributed are not left (NO in ACT109), the processing of the processor 21 proceeds to ACT111. In the above-mentioned ACT111, the determination module 213 of the processor 21 then determines a worker on a first-come and first-served basis.

In ACT112, the notification module 215 of the processor 21 notifies the information processing apparatus 10 of worker information regarding the worker determined by the determination module 213. Next, the processing proceeds to the processing of the information processing apparatus 10. In ACT113, the update module 116 of the processor 21 updates the shift data on the basis of the worker information from the information distribution apparatus 20. Thus, the processor 11 outputs the message addressed to an administrator to the terminal 3, and the processing of the processor 21 to determine a worker on a first-come and first-served basis within the third predetermined period is terminated.

According to this example, the information processing apparatus 10 can compare the number of necessary staff members and the number of registered staff members with each other on an hourly basis and output the information based on the comparison results. Thus, the information processing apparatus 10 can give support to secure an appropriate number of staff members according to the situation of the day in the store. Further, the information processing apparatus 10 can output the message addressed to an administrator to the terminal 3. Thus, the administrator can eventually determine whether to recruit workers or not.

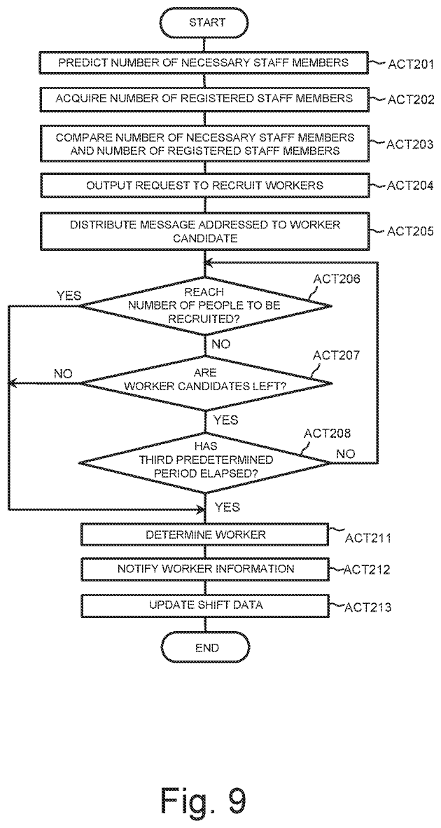

FIG. 9 is a flowchart showing another example of the operations of the processor 11 of the information processing apparatus 10 and the processor 21 of the information distribution apparatus 20 in the information processing system 1. In other words, here, an example in which the output module 115 of the processor 11 omits the output of the message addressed to an administrator to the terminal 3, and the determination module 213 of the processor 21 determines a worker on a first-come and first-served basis within the third predetermined period. ACT201 to ACT211 illustrated in FIG. 9 are respectively the same as ACT101 to ACT103 and ACT106 to ACT113 illustrated in FIG. 8. It should be noted that, in this example, in ACT204, the output module 115 of the processor 11 outputs a request to recruit workers to the information distribution apparatus 20 after the processing of comparison by the comparison module 114 in ACT203. Therefore, the output module 115 does not output (omits the output of) the message addressed to an administrator to the terminal 3 unlike the example of FIG. 8.

According to this example, the information processing system 1 can distribute the message addressed to a worker candidate to the terminals 4 without outputting the message addressed to an administrator to the terminal 3. The information processing system 1 can avoid a time loss such as missing of the message addressed to an administrator by the administrator, and can secure workers promptly.

The above embodiment has described the example in which the first distribution module 212 of the processor 21 distributes the message addressed to a worker candidate all together to the terminals 4 of worker candidates extracted by the extraction module 211. However, the embodiment is not limited to such an example. The first distribution module 212 may distribute the message addressed to a worker candidate to the terminals 4 with time intervals for each of groups of worker candidates classified by the extraction module 211. For example, the groups may correspond to the distances from the store. The first distribution module 212 distributes the message addressed to a worker candidate to the terminals 4 with time intervals sequentially from a group with a distance closer to the store. Thus, the information distribution apparatus 20 can secure workers having the addresses closer to the store. For example, the groups may correspond to the performance in employment. The first distribution module 212 distributes the message addressed to a worker candidate to the terminals 4 with time intervals sequentially from a group with higher performance in employment. Thus, the information distribution apparatus 20 can secure workers having high performance in employment.

The above embodiment has described the example in which the prediction module 113 of the processor 11 predicts a congestion situation as the situation of the store. However, the embodiment is not limited to such an example. The situation of the store may be goods sales performance. The prediction module 113 may predict sales performance per time slot by the comparison between inventory data and sales data of goods after checkout. The prediction module 113 may refer to the data, by which the sales performance and the number of necessary staff members are associated with each other, to predict the number of staff members necessary on an hourly basis. As the sales performance increases, the number of necessary staff members for the checkout operation tends to increase.

The above embodiment has described the example of the checkout operation as a predetermined operation. However, the embodiment is not limited to such an example. Further, the embodiment can be applied to various operations such as a goods-supplementing operation. For example, the prediction module 113 of the processor 11 uses the above-mentioned congestion situation as the situation of the store. The prediction module 113 predicts the number of staff members necessary on an hourly basis in the goods-supplementing operation of the store on the basis of the congestion situation. As the degree of congestion becomes higher, the goods tends to be more sold, and the number of necessary staff members in the goods-supplementing operation tends to increase. For example, the prediction module 113 uses the sales performance described above as the situation of the store. The prediction module 113 predicts the number of staff members necessary on an hourly basis in the goods-supplementing operation of the store on the basis of the sales performance. As the sales performance becomes higher, the number of necessary staff members in the goods-supplementing operation tends to increase. For example, the prediction module 113 uses an arrival situation of delivery trucks as the situation of the store. The arrival situation of delivery trucks is a time at which a truck that delivers goods to the store arrives. The information processing apparatus 10 can acquire information indicating the arrival situation of delivery trucks from a truck allocating company via a network. The prediction module 113 predicts the number of staff members necessary on an hourly basis in the goods-supplementing operation of the store on the basis of the arrival situation of delivery trucks. When a delivery truck arrives at the store, the number of necessary staff members for the goods-supplementing operation tends to increase.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a storage device that stores
data regarding stay of shoppers who come in and go out of a store, and
data regarding a shift of staff for a predetermined operation of the store;
a network interface;
a memory that stores a program; and
a processor that executes the program to
refer to the data regarding stay of shoppers to predict a situation of the store,
predict the number of staff members necessary on an hourly basis in the predetermined operation of the store on a basis of the situation of the store,
acquire the number of staff members registered on an hourly basis in the predetermined operation on a basis of the data regarding a shift of staff for the predetermined operation,
compare the number of staff members necessary and the number of staff members registered with each other on an hourly basis, and
output information of results of the comparison via the network interface, the information including information indicating a time slot insufficient in staff and information indicating the number of insufficient staff members when the number of staff members necessary exceeds the number of staff members registered.

2. The information processing apparatus according to claim 1, wherein
the processor outputs the information of results of the comparison to a terminal of an administrator of the store via the network interface.

3. The information processing apparatus according to claim 1, wherein
the processor
predicts the number of staff members necessary at a plurality of prediction timings of a day, and
compares the number of staff members necessary and the number of staff members registered with each other on an hourly basis in a predetermined period.

4. The information processing apparatus according to claim 3, wherein
the processor
predicts, at each of the plurality of prediction timings of the day, the number of staff members necessary on an hourly basis in a first predetermined period later than each of the plurality of prediction timings, and
compares the number of staff members necessary and the number of staff members registered with each other on an hourly basis in the first predetermined period.

5. The information processing apparatus according to claim 4, wherein
the first predetermined period is a time period that starts at a time after an elapse of a second predetermined period starting from a time of the prediction timing.

6. An information processing system, comprising
an information processing apparatus that acquires a situation in which staff members are insufficient in a predetermined operation of a store; and
an information distribution apparatus that gives support to secure a worker for the predetermined operation on a basis of the situation in which staff members are insufficient, the situation being acquired by the information processing apparatus,
the information processing apparatus including
a first storage device that stores
data regarding stay of shoppers who come in and go out of a store, and
data regarding a shift of staff for a predetermined operation of the store,
a first network interface,
a first memory that stores an information processing program, and
a first processor that executes the information processing program to
refer to the data regarding stay of shoppers to predict a situation of the store,
predict the number of staff members necessary on an hourly basis in the predetermined operation of the store on a basis of the situation of the store,
acquire the number of staff members registered on an hourly basis in the predetermined operation on a basis of the data regarding a shift of staff for the predetermined operation,
compare the number of staff members necessary and the number of staff members registered with each other on an hourly basis, and
output information of results of the comparison to the information distribution apparatus via the first network interface, the information including information indicating a time slot insufficient in staff and information indicating the number of insufficient staff members when the number of staff members necessary exceeds the number of staff members registered,
the information distribution apparatus including
a second storage device that stores data regarding worker candidates,
a second network interface,
a second memory that stores an information distribution program, and
a second processor that executes the information distribution program to
acquire the information of results of the comparison from the information processing apparatus via the second network interface,
refer to the data regarding worker candidates to extract a worker candidate who satisfies a predetermined criterion, and
distribute information of recruiting workers to a terminal of the extracted worker candidate via the second network interface, the information being included in the information of results of the comparison and being based on the information indicating the time slot insufficient in staff and the information indicating the insufficient number of staff of the store.

7. The information processing system according to claim 6, wherein
the first processor
predicts, at each of a plurality of prediction timings of a day, the number of staff members necessary on an hourly basis in a predetermined period later than each of the plurality of prediction timings, and
compares the number of staff members necessary and the number of staff members registered with each other on an hourly basis in the predetermined period.

8. The information processing system according to claim 6, wherein
the second processor further
receives an application for the information of recruiting workers from each of the worker candidates via the second network interface within a predetermined period after distribution of the information of recruiting workers, and
refers to the data regarding worker candidates stored in the second storage device from the worker candidates whose applications are received, to determine a worker for the information of recruiting workers.

9. The information processing system according to claim 8, wherein
the data regarding worker candidates stored in the second storage device includes data regarding an address of each of the worker candidates, and
the second processor refers to the data regarding an address of each of the worker candidates to determine a worker for the information of recruiting workers from the worker candidates whose applications are received, in an order of a distance closer to the address of each of the worker candidates from an address of the store.

10. An information processing method, comprising:
storing, in a storage device in advance, data regarding stay of shoppers who come in and go out of a store and data regarding a shift of staff for a predetermined operation of the store;
referring to the data regarding stay of shoppers to predict a situation of the store;
predicting the number of staff members necessary on an hourly basis in the predetermined operation of the store on a basis of the situation of the store,
acquiring the number of staff members registered on an hourly basis in the predetermined operation on a basis of the data regarding a shift of staff for the predetermined operation;
comparing the number of staff members necessary and the number of staff members registered with each other on an hourly basis; and
outputting information based on results of the comparison via the network interface.
